(19) United States
(12) Patent Application Publication
(10) Pub. No.: US 2016/0012375 A1
(43) Pub. Date: Jan. 14, 2016

(54) Managing Customer Queues Using Local Positioning Technology

(71) Applicant: Bank of America Corporation, Charlotte, NC (US)

(72) Inventors: Carrie Anne Hanson, Charlotte, NC (US); Don Cardinal, San Antonio, TX (US); Sharon Scanlon, Manahawkin, NJ (US); Davindar Gill, Palatine, IL (US)

(21) Appl. No.: 14/327,688

(22) Filed: Jul. 10, 2014

(51) Int. Cl. G06Q 10/06

(52) U.S. Cl. CPC G06Q 10/063114; G06Q 40/02

(57) ABSTRACT

Methods and systems for managing customer queues using local positioning technology are presented. In some embodiments, a customer assistance computing platform may receive one or more attributes associated with a beacon signal received by a customer computing device and an identifier associated with the customer computing device. Subsequently, the computing platform may determine an identity of a customer using the customer computing device. The computing platform then may determine a location of the customer using the customer computing device based on the one or more attributes associated with the beacon signal. Thereafter, the computing platform may select at least one queue from one or more maintained queues based on the location of the customer. Then, the computing platform may update the at least one selected queue based on the identity of the customer to add the customer using the customer computing device to the at least one selected queue.

### BACKGROUND

Aspects of the disclosure relate to computer hardware and software. In particular, one or more aspects of the disclosure generally relate to computer hardware and software for managing customer queues using local positioning technology.

Many people are increasingly using mobile devices, such as smart phones, tablet computers, wearable devices (e.g., augmented reality glasses, smart watches, and the like), and other types of personal computing devices and mobile computing devices, for a variety of different purposes. As these devices grow more and more popular, users of such devices increasingly demand greater functionality and convenience from such devices, and various organizations and other business entities in turn may be presented with new opportunities to engage and interact with customers and potential customers via such devices.

Although it may be possible for an organization to provide all sorts of information to its customers and potential customers via their mobile devices, it may still remain difficult to engage and interact with customers and potential customers via such devices at the right time, in the right place, with the right information, and/or in an otherwise contextually-relevant way.

### SUMMARY

Aspects of the disclosure relate to various systems and techniques that provide effective, efficient, scalable, and convenient ways of engaging customers and potential customers in contextually-relevant ways, particularly in ways that involve managing customer queues using local positioning technology, such as indoor positioning technology.

In accordance with one or more embodiments, a customer assistance computing platform that includes at least one processor, memory, and a communication interface may receive, via the communication interface, from a customer computing device, one or more attributes associated with a beacon signal received by the customer computing device and an identifier associated with the customer computing device. Subsequently, the customer assistance computing platform may determine an identity of a customer using the customer computing device based on the identifier associated with the customer computing device. The customer assistance computing platform then may determine a location of the customer using the customer computing device based on the one or more attributes associated with the beacon signal received by the customer computing device. Thereafter, the customer assistance computing platform may select at least one queue from one or more maintained queues based on the location of the customer using the customer computing device. Then, the customer assistance computing platform may update the at least one selected queue based on the identity of the customer using the customer computing device to add the customer using the customer computing device to the at least one selected queue.

In some embodiments, the beacon signal received by the customer computing device may be associated with at least one beacon deployed at a banking center. In addition, the one or more attributes associated with the beacon signal received by the customer computing device may, in some instances, include a unique identifier associated with the at least one beacon deployed at the banking center.

In some embodiments, the identifier associated with the customer computing device may include user account information associated with a mobile banking application on the customer computing device. In some instances, the customer assistance computing platform may receive, via the communication interface, from the customer computing device, biometric input information captured by the mobile banking application on the customer computing device. In addition, determining the identity of the customer using the customer computing device may, in some instances, include confirming the identity of the customer using the customer computing device based on the biometric input information captured by the mobile banking application on the customer computing device.

In some embodiments, determining the location of the customer using the customer computing device may include accessing beacon deployment information that maps identifiers for a plurality of beacons to corresponding deployment locations of the plurality of beacons. In some instances, determining the location of the customer using the customer computing device may include determining that the customer using the customer computing device is located in a specific area of the banking center.

In some embodiments, selecting at least one queue from the one or more maintained queues may include selecting a general queue of one or more customers waiting for service at the banking center. In addition, the customer assistance computing platform may, in some instances, generate a notification indicating that the customer using the customer computing device has been added to the general queue of one or more customers waiting for service at the banking center. The customer assistance computing platform also may send, via the communication interface, to the customer computing device, the notification.

In some embodiments, the customer assistance computing platform may access appointment information associated with the customer using the customer computing device. In addition, the customer assistance computing platform may generate, based on the appointment information associated with the customer using the customer computing device, a request for visit information associated with the customer's current visit to the banking center. The customer assistance computing platform also may send, via the communication interface, to the customer computing device, the request for visit information.

In some embodiments, the customer assistance computing platform may receive, via the communication interface, from the customer computing device, visit input provided in response to the request for visit information. Subsequently, the customer assistance computing platform may select, based on the visit input, at least one service-specific queue from the one or more maintained queues. Then, the customer assistance computing platform may update the at least one selected service-specific queue based on the identity of the customer using the customer computing device to add the customer using the customer computing device to the at least one selected service-specific queue.

In some embodiments, each of the at least one selected service-specific queue may provide a separate virtual waiting line for one or more customers waiting for a specific service of one or more available services at the banking center. In some instances, the customer using the customer computing device may be placed in a dedicated queue of one or more customers who have arrived at the banking center early for one or more corresponding appointments.

In some embodiments, the customer using the customer computing device may be pre-authenticated to perform one or more specific transactions based on the appointment information and the visit input. Additionally or alternatively, the customer using the customer computing device may be pre-authenticated to perform one or more specific transactions based on biometric input information received from the customer computing device.

In some embodiments, the customer assistance computing platform may determine that a banking center associate at the banking center is available to assist one or more customers at the banking center. Subsequently, the customer assistance computing platform may select the customer using the customer computing device from the at least one queue to receive assistance from the banking center associate. Then, the customer assistance computing platform may generate a first notification indicating that the customer using the customer computing device has been selected to receive assistance from the banking center associate. Next, the customer assistance computing platform may send, via the communication interface, to the customer computing device, the first notification. Thereafter, the customer assistance computing platform may generate a second notification indicating that the banking center associate has been assigned to assist the customer using the customer computing device. Subsequently, the customer assistance computing platform may send, via the communication interface, to a computing device associated with the banking center associate, the second notification. In some instances, the first notification may include a picture of the banking center associate.

These features, along with many others, are discussed in greater detail below.

### BRIEF DESCRIPTION OF THE DRAWINGS

The present disclosure is illustrated by way of example and not limited in the accompanying figures in which like reference numerals indicate similar elements and in which:

FIG. 1 depicts an illustrative operating environment in which various aspects of the disclosure may be implemented in accordance with one or more example embodiments;

FIG. 2 depicts an illustrative block diagram of workstations and servers that may be used to implement the processes and functions of certain aspects of the present disclosure in accordance with one or more example embodiments;

FIG. 3 depicts an illustrative computing environment for managing customer queues using local positioning technology in accordance with one or more example embodiments;

FIGS. 4A-4I depict an illustrative event sequence for managing customer queues using local positioning technology in accordance with one or more example embodiments;

FIGS. 5-8 depict example graphical user interfaces for managing customer queues using local positioning technology in accordance with one or more example embodiments; and

FIG. 9 depicts an illustrative method for managing customer queues using local positioning technology in accordance with one or more example embodiments.

### DETAILED DESCRIPTION

In the following description of various illustrative embodiments, reference is made to the accompanying drawings, which form a part hereof, and in which is shown, by way of illustration, various embodiments in which aspects of the disclosure may be practiced. It is to be understood that other embodiments may be utilized, and structural and functional modifications may be made, without departing from the scope of the present disclosure.

It is noted that various connections between elements are discussed in the following description. It is noted that these connections are general and, unless specified otherwise, may be direct or indirect, wired or wireless, and that the specification is not intended to be limiting in this respect.

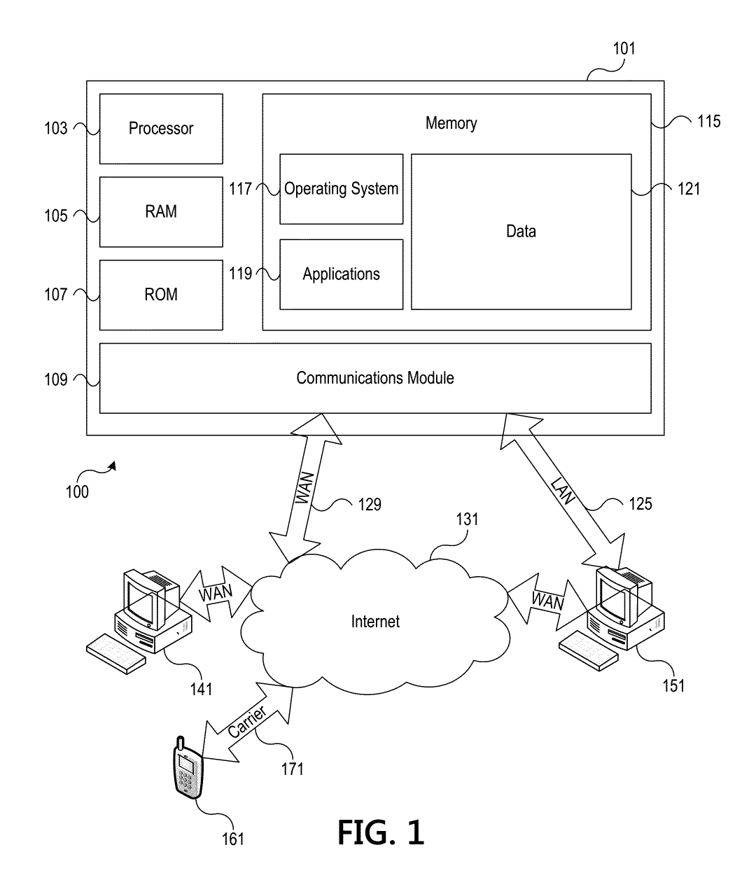

FIG. 1 depicts an illustrative operating environment in which various aspects of the present disclosure may be implemented in accordance with one or more example embodiments. Referring to FIG. 1, computing system environment 100 may be used according to one or more illustrative embodiments. Computing system environment 100 is only one example of a suitable computing environment and is not intended to suggest any limitation as to the scope of use or functionality contained in the disclosure. Computing system environment 100 should not be interpreted as having any dependency or requirement relating to any one or combination of components shown in illustrative computing system environment 100.

Computing system environment 100 may include computing device 101 having processor 103 for controlling overall operation of computing device 101 and its associated components, including random-access memory (RAM) 105, read-only memory (ROM) 107, communications module 109, and memory 115. Computing device 101 may include a variety of computer readable media. Computer readable media may be any available media that may be accessed by computing device 101, may be non-transitory, and may include volatile and nonvolatile, removable and non-removable media implemented in any method or technology for storage of information such as computer-readable instructions, object code, data structures, program modules, or other data. Examples of computer readable media may include random access memory (RAM), read only memory (ROM), electronically erasable programmable read only memory (EEPROM), flash memory or other memory technology, compact disk read-only memory (CD-ROM), digital versatile disks (DVD) or other optical disk storage, magnetic cassettes, magnetic tape, magnetic disk storage or other magnetic storage devices, or any other medium that can be used to store the desired information and that can be accessed by computing device 101.

Although not required, various aspects described herein may be embodied as a method, a data processing system, or as a computer-readable medium storing computer-executable instructions. For example, a computer-readable medium storing instructions to cause a processor to perform steps of a method in accordance with aspects of the disclosed embodiments is contemplated. For example, aspects of the method steps disclosed herein may be executed on a processor on computing device 101. Such a processor may execute computer-executable instructions stored on a computer-readable medium.

Software may be stored within memory 115 and/or storage to provide instructions to processor 103 for enabling computing device 101 to perform various functions. For example, memory 115 may store software used by computing device 101, such as operating system 117, application programs 119, and associated database 121. Also, some or all of the computer executable instructions for computing device 101 may be embodied in hardware or firmware.

Although not shown, RAM 105 may include one or more applications representing the application data stored in RAM 105 while computing device 101 is on and corresponding software applications (e.g., software tasks), are running on computing device 101.

Communications module 109 may include a microphone, keypad, touch screen, and/or stylus through which a user of computing device 101 may provide input, and may also include one or more of a speaker for providing audio output and a video display device for providing textual, audiovisual and/or graphical output. Computing system environment 100 may also include optical scanners (not shown). Exemplary usages include scanning and converting paper documents, e.g., correspondence, receipts, and the like, to digital files.

Computing device 101 may operate in a networked environment supporting connections to one or more remote computing devices, such as computing devices 141, 151, and 161. Computing devices 141, 151, and 161 may be personal computing devices or servers that include any or all of the elements described above relative to computing device 101. Computing device 161 may be a mobile device (e.g., smart phone) communicating over wireless carrier channel 171.

The network connections depicted in FIG. 1 may include local area network (LAN) 125 and wide area network (WAN) 129, as well as other networks. When used in a LAN networking environment, computing device 101 may be connected to LAN 125 through a network interface or adapter in communications module 109. When used in a WAN networking environment, computing device 101 may include a modem in communications module 109 or other means for establishing communications over WAN 129, such as Internet 131 or other type of computer network. The network connections shown are illustrative and other means of establishing a communications link between the computing devices may be used. Various well-known protocols such as transmission control protocol/Internet protocol (TCP/IP), Ethernet, file transfer protocol (FTP), hypertext transfer protocol (HTTP) and the like may be used, and the system can be operated in a client-server configuration to permit a user to retrieve web pages from a web-based server. Any of various conventional web browsers can be used to display and manipulate data on web pages.

The disclosure is operational with numerous other general purpose or special purpose computing system environments or configurations. Examples of well-known computing systems, environments, and/or configurations that may be suitable for use with the disclosed embodiments include, but are not limited to, personal computers (PCs), server computers, hand-held or laptop devices, smart phones, multiprocessor systems, microprocessor-based systems, set top boxes, programmable consumer electronics, network PCs, minicomputers, mainframe computers, distributed computing environments that include any of the above systems or devices, and the like.

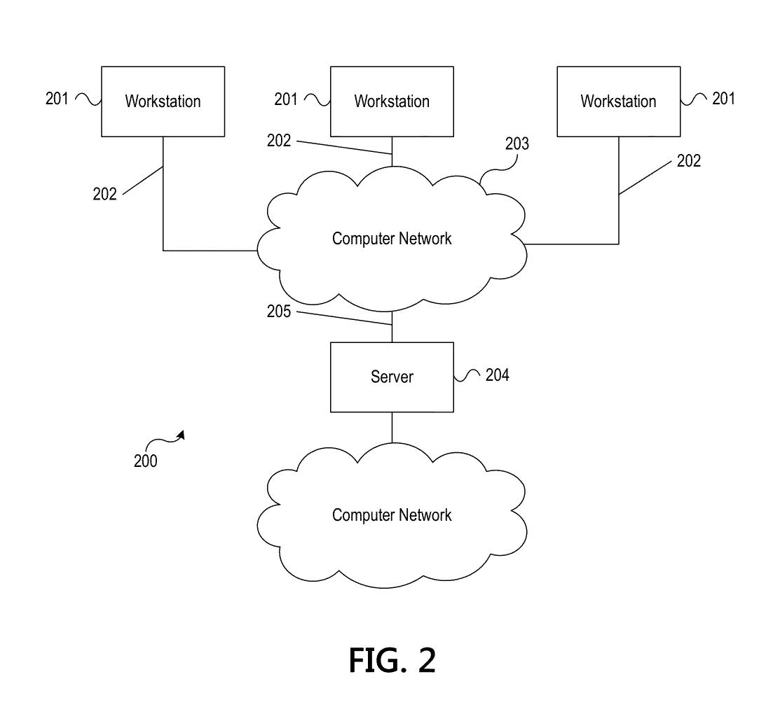

FIG. 2 depicts an illustrative block diagram of workstations and servers that may be used to implement the processes and functions of certain aspects of the present disclosure in accordance with one or more example embodiments. Referring to FIG. 2, illustrative system 200 may be used for implementing example embodiments according to the present disclosure. As illustrated, system 200 may include one or more workstation computers 201. Workstation 201 may be, for example, a desktop computer, a smartphone, a wireless device, a tablet computer, a laptop computer, and the like. Workstations 201 may be local or remote, and may be connected by one of communications links 202 to computer network 203 that is linked via communications link 205 to server 204. In system 200, server 204 may be any suitable server, processor, computer, or data processing device, or combination of the same. Server 204 may be used to process the instructions received from, and the transactions entered into by, one or more participants.

Computer network 203 may be any suitable computer network including the Internet, an intranet, a wide-area network (WAN), a local-area network (LAN), a wireless network, a digital subscriber line (DSL) network, a frame relay network, an asynchronous transfer mode (ATM) network, a virtual private network (VPN), or any combination of any of the same. Communications links 202 and 205 may be any communications links suitable for communicating between workstations 201 and server 204, such as network links, dial-up links, wireless links, hard-wired links, as well as network types developed in the future, and the like.

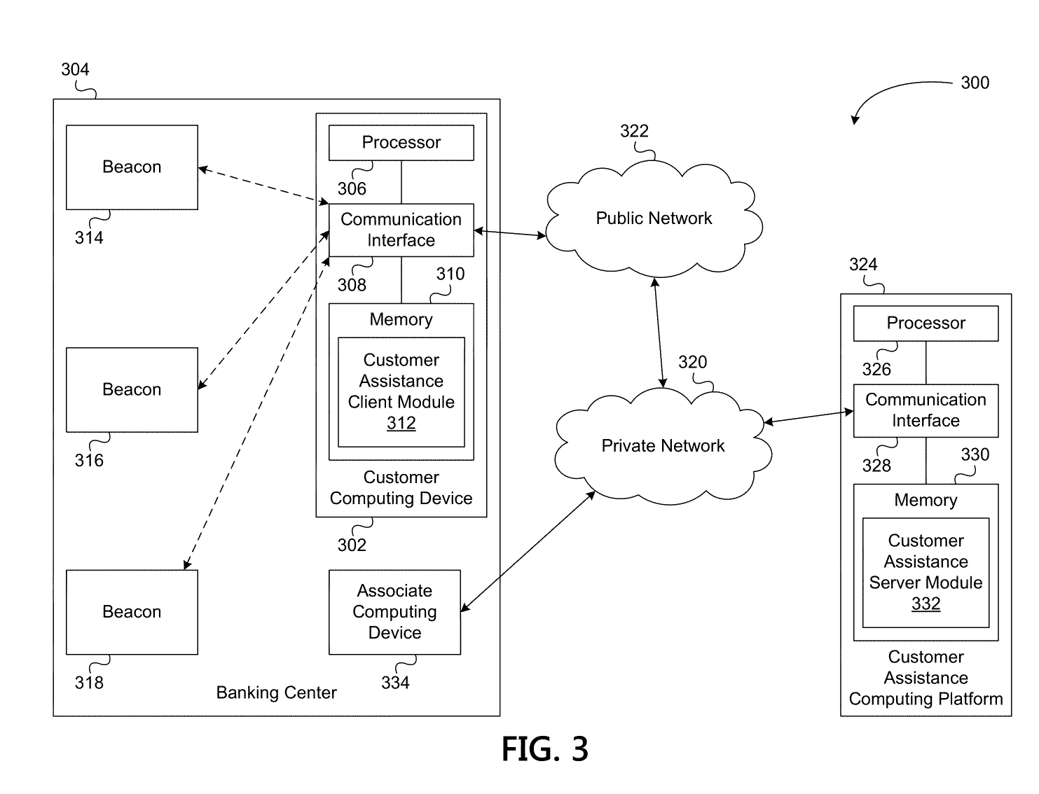

FIG. 3 depicts an illustrative computing environment for managing customer queues using local positioning technology in accordance with one or more example embodiments. Referring to FIG. 3, computing environment 300 may include one or more computing devices, such as customer computing device 302. Customer computing device 302 may be any type of computing device capable of receiving a user interface, receiving input via the user interface, and communicating the received input to one or more other computing devices. For example, customer computing device 302 may be a desktop computer, laptop computer, tablet computer, smart phone, or the like. In one or more arrangements, customer computing device 302 may be a personal computing device, such as a mobile computing device (e.g., a smart phone, a tablet computer, a wearable computer, augmented reality glasses, or any other type of mobile device), that belongs to and/or is used by a customer of a financial institution at and/or near a banking center 304 and/or any other location operated by, controlled by, and/or otherwise associated with the financial institution.

Computing environment 300 also may include one or more location beacons, such as location beacon 314, location beacon 316, and location beacon 318. Each location beacon (e.g., location beacon 314, location beacon 316, and location beacon 318) may be configured to transmit one or more radio signals that may be detected and/or received by other devices located in close proximity of and/or otherwise within a predetermined distance of the particular location beacon. In one or more embodiments, any and/or all of the location beacons included in computing environment 300 (e.g., location beacon 314, location beacon 316, and location beacon 318) may implement Bluetooth Low Energy (also referred to as “Bluetooth LE,” “Bluetooth Smart,” or “BLE”) technology to transmit low-power radio signals. The particular signal(s) transmitted by a particular location beacon may include one or more attributes, such as a unique identifier assigned to and/or otherwise associated with the particular location beacon, that may enable the particular location beacon to be identified by a device receiving the particular signal(s) transmitted by the particular location beacon. As illustrated below, by detecting a particular signal transmitted by a location beacon (which may, e.g., be positioned at a specific location) and subsequently identifying the location beacon transmitting the particular signal, a computing device may be able to determine that it located at and/or near the specific location where the location beacon is positioned.

For example, in one or more arrangements discussed below, the one or more location beacons (e.g., location beacon 314, location beacon 316, and location beacon 318) may be positioned at and/or near banking center 304, and may be specifically positioned at and/or near different areas of banking center 304, such as at a welcome area, at a teller counter or window, at a waiting area, at an external alcove where an automated teller machine (ATM) is located, at an external window where drive-up services are provided, at a parking lot, and/or in one or more other distinct areas of banking center 304. In addition, each location beacon may transmit a radio signal that may be detected and/or received by other devices at banking center 304, such as customer computing device 302, which may enable such devices to determine that they are present at banking center 304 and/or located at and/or near a particular area of banking center 304.

In one or more embodiments, customer computing device 302 may include at least one processor 306, communication interface 308, and/or memory 310. A data bus may interconnect processor 306, communication interface 308, and/or memory 310. Memory 310 may include one or more program modules comprising instructions that when executed by processor 306 cause customer computing device 302 to perform one or more functions described herein. For example, memory 310 may include customer assistance client module 312, which may include instructions that when executed by processor 306 cause customer computing device 302 to perform one or more functions described herein. Communication interface 308 may include one or more wired and/or wireless communication interfaces (e.g., network interfaces, radio interfaces, or the like) that are configured to support communication between customer computing device 302 and one or more other devices and/or networks. In one or more arrangements, communication interface 308 may include at least one network interface that facilitates communication between customer computing device 302 and one or more devices and/or networks that are located remotely from banking center 304, and communication interface 308 may further include at least one radio interface that facilitates communication between and/or enables customer computing device 302 to receive wireless radio signals from one or more location beacons (e.g., location beacon 314, location beacon 316, and location beacon 318) and/or other radio transmitters that may be located at and/or near banking center 304.

Computing environment 300 also may include one or more computing platforms. For example, computing environment 300 may include customer assistance computing platform 324. Customer assistance computing platform 324 may include one or more computing devices configured to perform one or more of the functions described herein. For example, customer assistance computing platform 324 may include one or more computers (e.g., laptop computers, desktop computers, servers, server blades, or the like).

Computing environment 300 also may include one or more networks, which may interconnect customer computing device 302, customer assistance computing platform 324, and/or one or more other computing devices. For example, computing environment 300 may include private network 320 and public network 322. Private network 320 and/or public network 322 may include one or more sub-networks (e.g., LANs, WANs, or the like). Private network 320 may be associated with a particular organization (e.g., a corporation, financial institution, educational institution, governmental institution, or the like) and may interconnect one or more computing devices associated with the organization. For example, customer assistance computing platform 324 may be associated with an organization, such as the financial institution that operates, controls, and/or is otherwise associated with banking center 304, and private network 320 may be operated by and/or otherwise associated with the organization, and may include one or more networks (e.g., LANs, WANs, VPNs, or the like) that interconnect customer assistance computing platform 324 and one or more other computing devices associated with the organization. Public network 322 may connect private network 320 and/or one or more computing devices connected thereto (e.g., customer assistance computing platform 324) with one or more networks and/or computing devices that are not associated with the organization. For example, customer computing device 302 might not be associated with the organization that operates and/or is associated with private network 320, and public network 322 may include one or more networks (e.g., the Internet) that connect customer computing device 302 to private network 320 and/or one or more computing devices connected thereto (e.g., customer assistance computing platform 324).

Customer assistance computing platform 324 may include at least one processor 326, communication interface 328, and/or memory 330. Memory 330 may include one or more program modules comprising instructions that when executed by processor 326 cause customer assistance computing platform 324 to perform one or more functions described herein. For example, memory 330 may include customer assistance server module 332, which may include instructions that when executed by processor 326 cause customer assistance computing platform 324 to perform one or more functions described herein. Communication interface 328 may include one or more wired and/or wireless communication interfaces (e.g., network interfaces, radio interfaces, or the like) that are configured to support communication between customer assistance computing platform 324 and one or more other devices and/or networks. For example, communication interface 328 may include at least one network interface that facilitates communication between customer assistance computing platform 324 and one or more other devices and/or networks (e.g., private network 320, public network 322, customer computing device 302, and/or other devices and networks).

Computing environment 300 also may include a banking center associate computing device 334. Banking center associate computing device 334 may include one or more processors, memories, and/or communication interfaces, similar to those that may be included in customer computing device 302. In some instances, banking center associate computing device 334 may be used by an associate, employee, or agent of an organization that may operate the banking center 304, such as the financial institution that may operate the banking center 304, and/or may be used by any other individual associated with such the organization. Banking center associate computing device 334 may be configured to connect to private network 320 and/or may communicate with customer assistance computing platform 324 via private network 320 and one or more communication interfaces. Additionally or alternatively, banking center associate computing device 334 may be configured to connect to public network 322 and/or may communicate with one or more computing devices via public network 322 and one or more communication interfaces. In some instances, multiple banking center associate computing devices, each being similar to banking center associate computing device 334, may be present at a particular banking center, such as banking center 304, even though only one such banking center associate computing device is illustrated in the example depicted in FIG. 3. Similarly, multiple customer computing devices, each being similar to customer computing device 302, may be present at a particular banking center, such as banking center 304, even though only one such customer computing device is illustrated in the example depicted in FIG. 3. Additionally or alternatively, a particular banking center, such as banking center 304, may have any number of beacons, each being similar to beacons 314, 316, and 318, even though three such beacons are illustrated in the example depicted in FIG. 3.

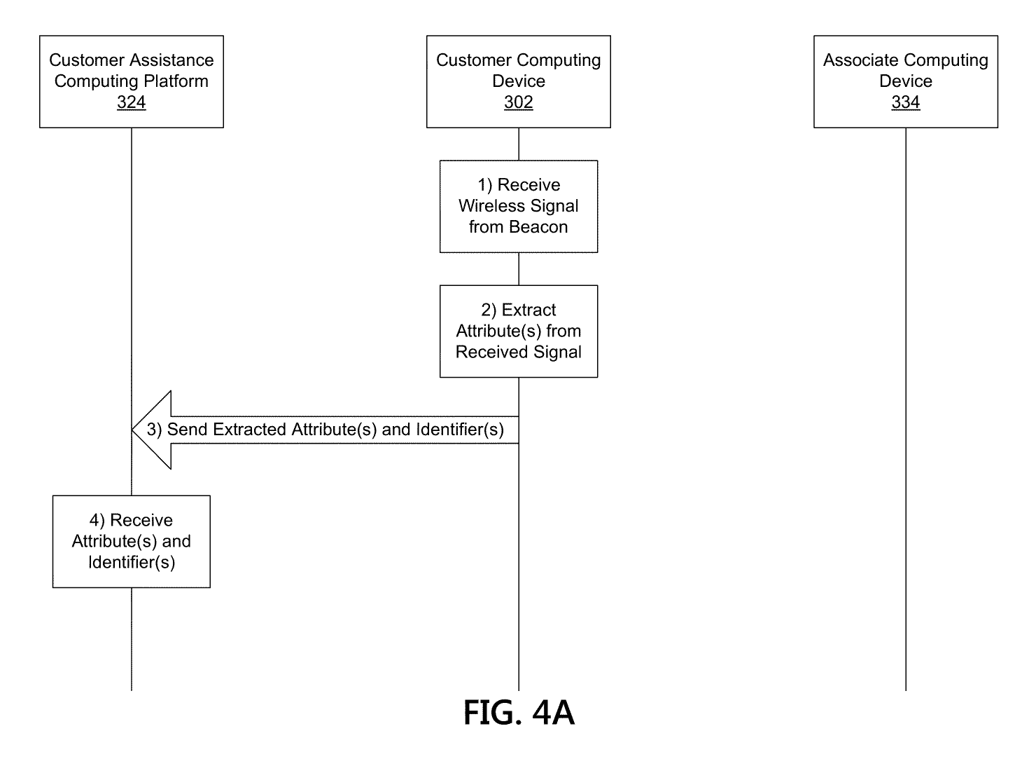

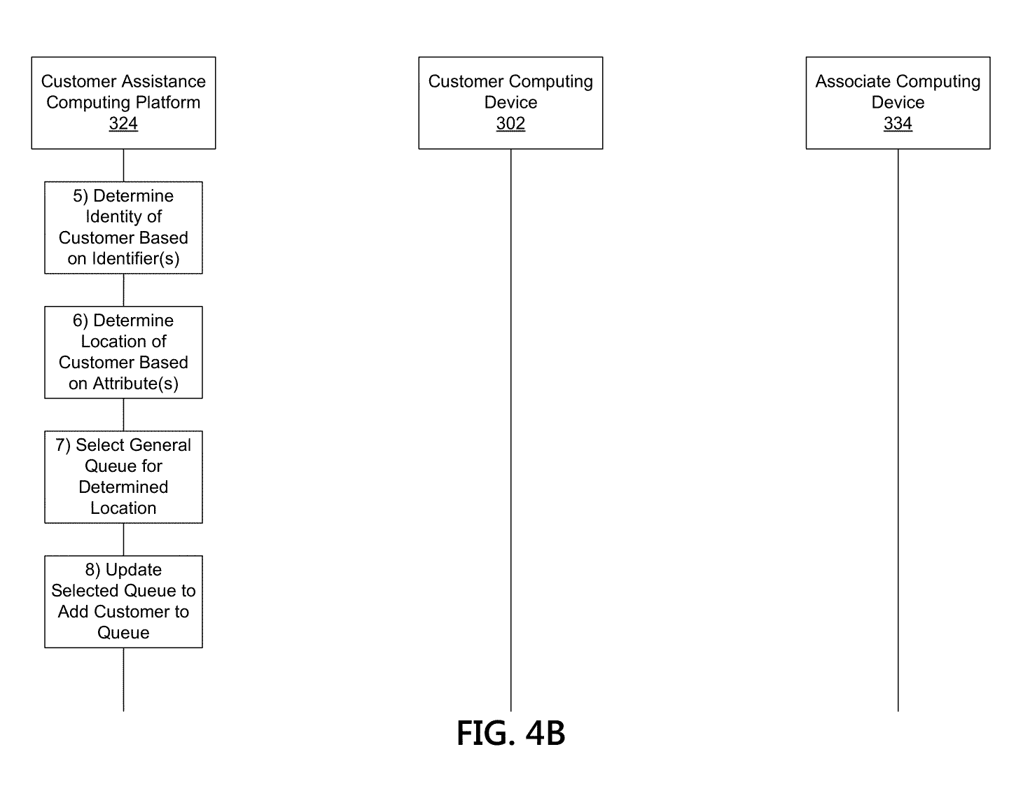

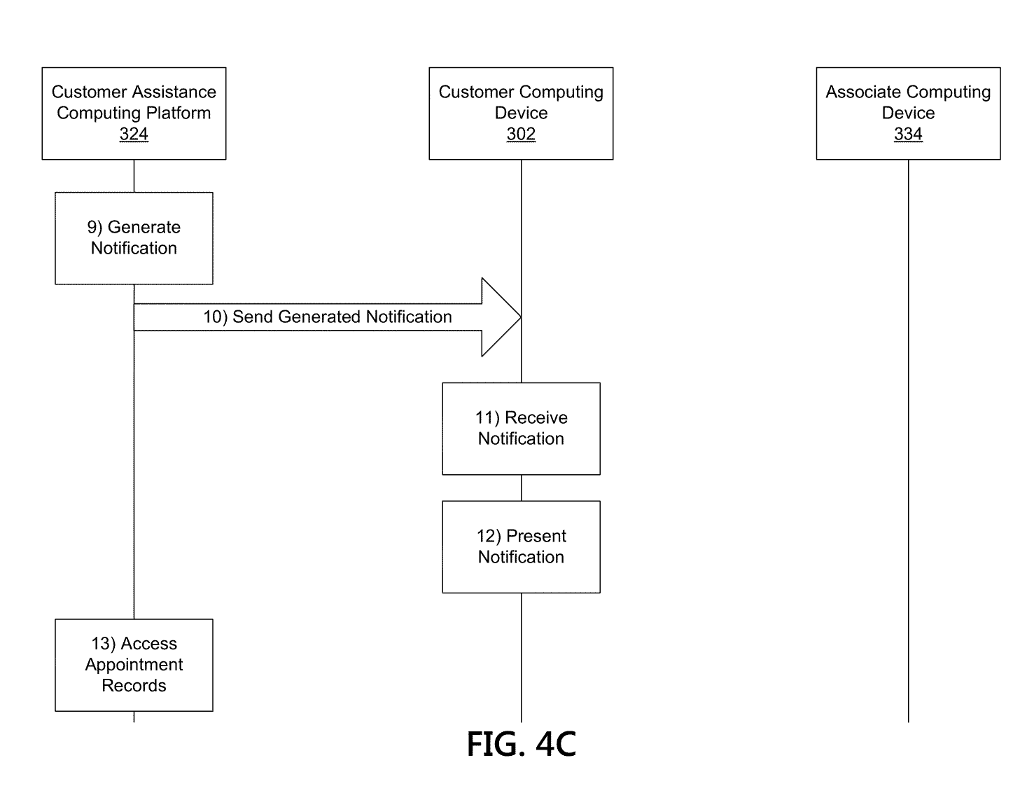

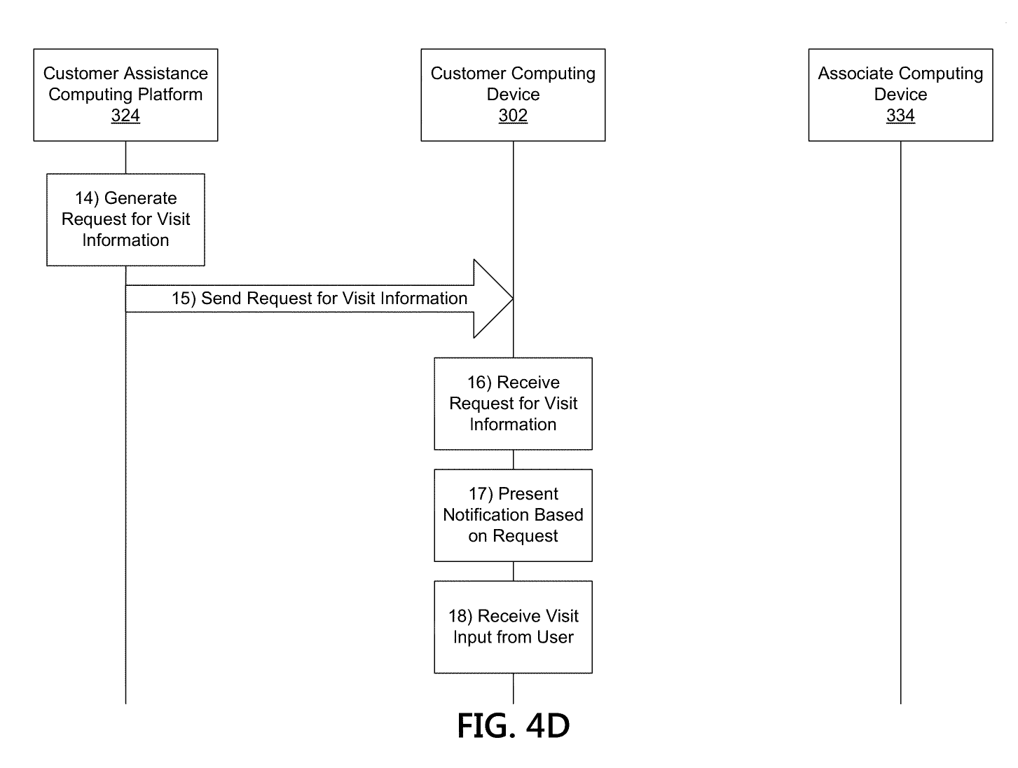

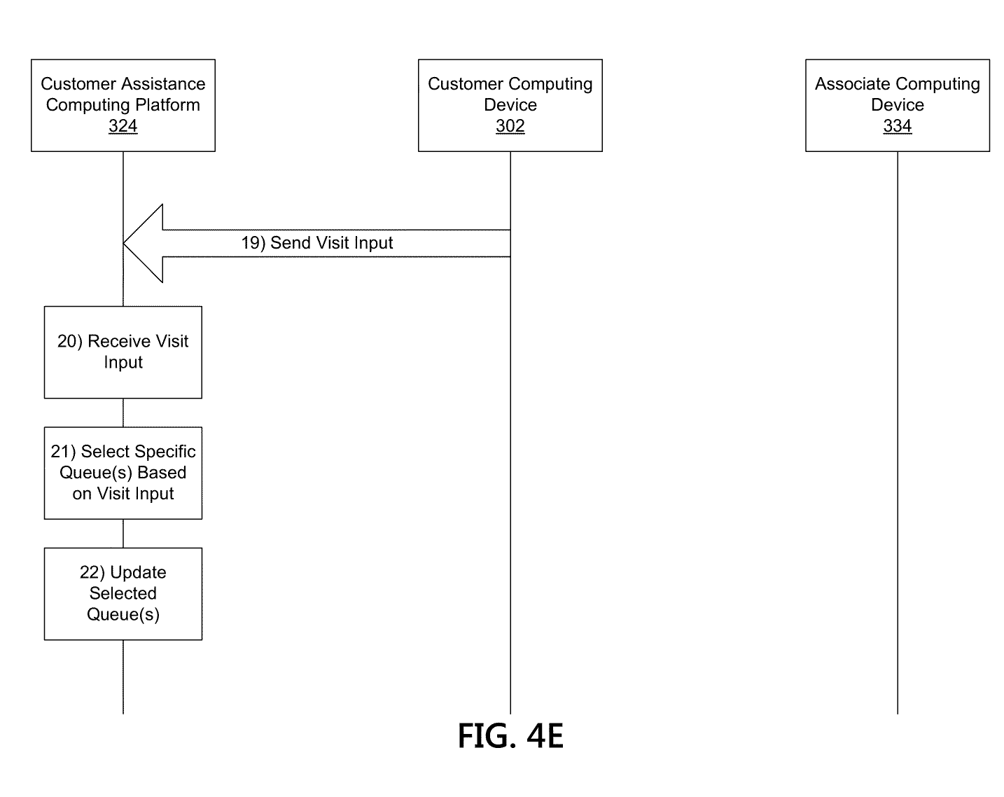

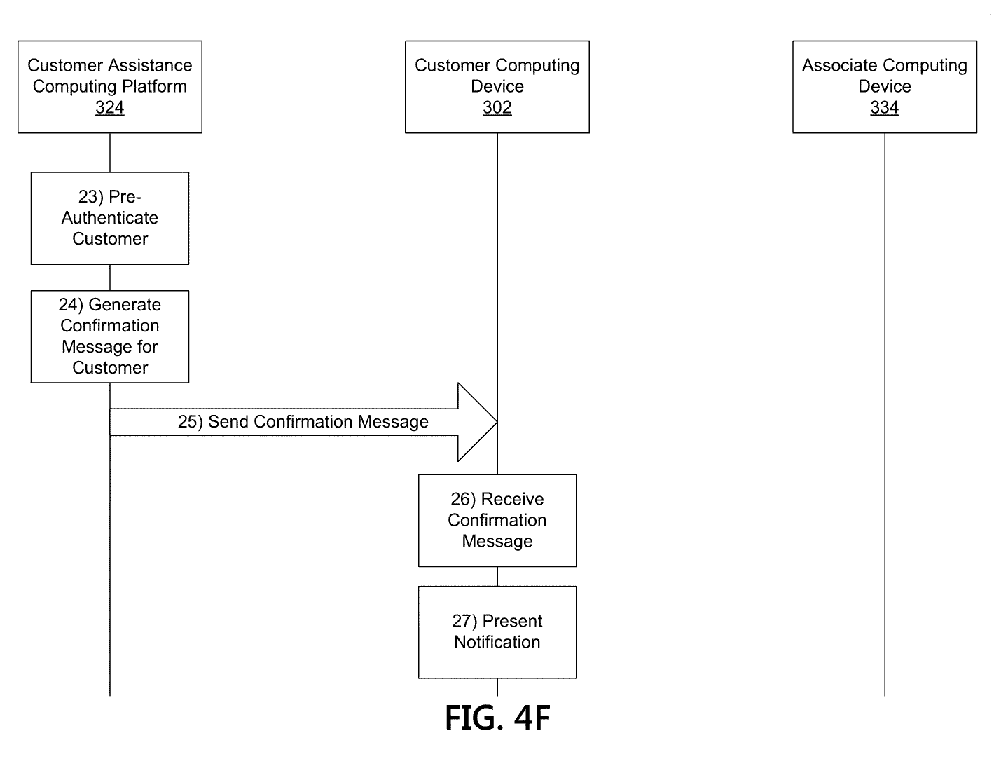

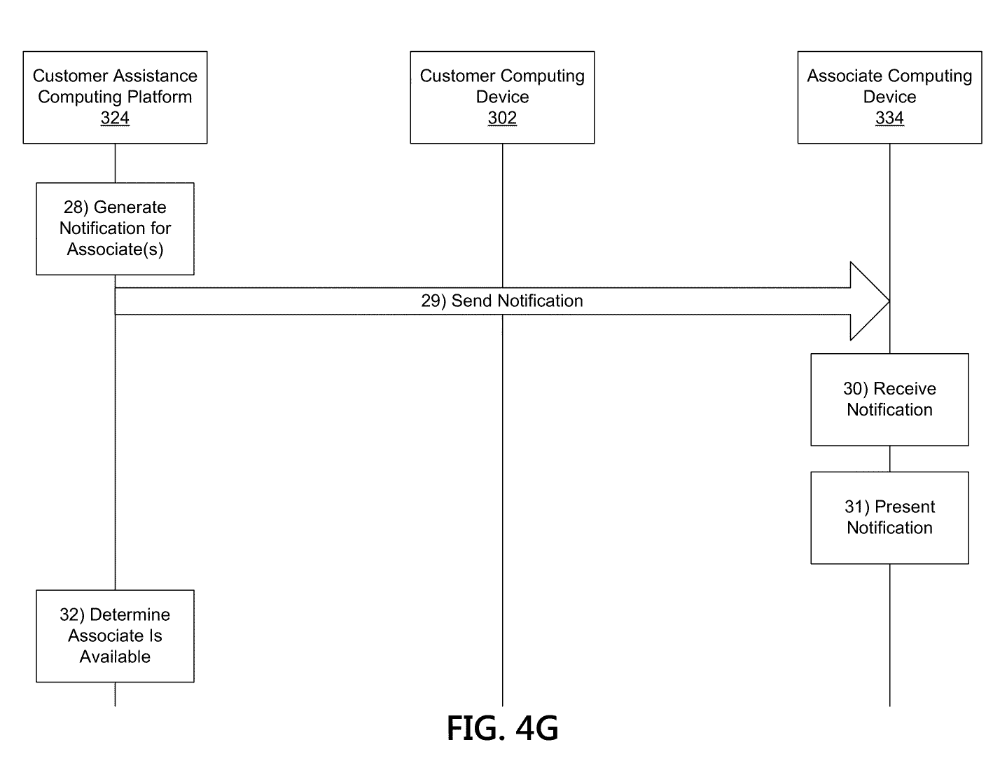

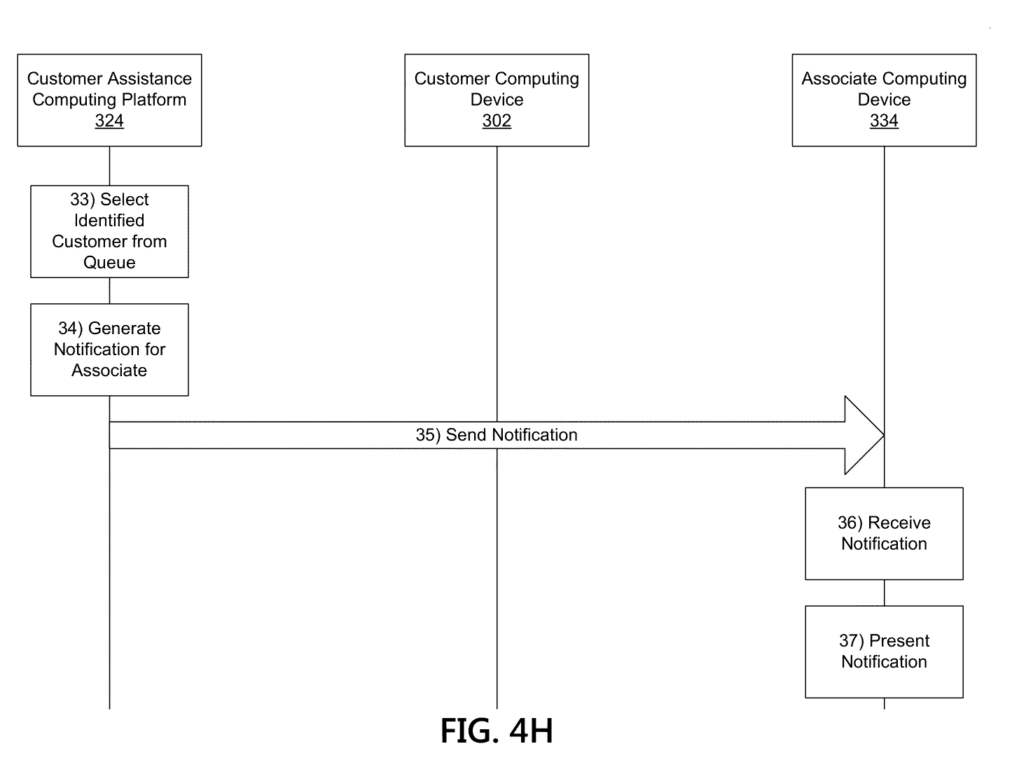

FIG. 4A-4I depict an illustrative event sequence for managing customer queues using local positioning technology in accordance with one or more example embodiments. Referring to FIG. 4A, at step 1, customer computing device 302 may receive a wireless signal from a location beacon. For example, customer computing device 302 may receive such a wireless signal from one or more of beacon 314, beacon 316, and/or beacon 318. Such a wireless signal, which also may be referred to as a “beacon signal,” may be received when (and/or just before and/or after) a user of customer computing device 302 arrives at, enters, and/or otherwise visits banking center 304 (or any other location where the location beacon(s) may be deployed). Thus, the beacon signal received by the customer computing device may, in some instances, be associated with at least one beacon deployed at a banking center, such as banking center 304.

At step 2, customer computing device 302 may extract one or more attributes from the wireless signal received from the location beacon. For example, in extracting one or more attributes from the beacon signal, customer computing device 302 may identify and/or otherwise determine a unique identifier assigned to and/or otherwise associated with the particular location beacon from which the beacon signal was received. If, for instance, a location beacon is deployed at a banking center, such as banking center 304, the one or more attributes associated with the beacon signal received by the customer computing device may include a unique identifier associated with the location beacon deployed at the banking center. Additionally or alternatively, in extracting one or more attributes from the beacon signal, customer computing device 302 may identify and/or otherwise determine one or more other attributes associated with the beacon signal, such as a frequency of the beacon signal, an amplitude of the beacon signal, a round trip time (RTT) value and/or a round trip delay (RTD) value for the beacon signal, an estimated range to the location beacon transmitting the beacon signal, and/or the like.

At step 3, customer computing device 302 may send, to customer assistance computing platform 324, the one or more attributes associated with the beacon signal and/or one or more identifiers associated with customer computing device 302. For example, customer computing device 302 may send, to customer assistance computing platform 324, any and/or all of the attributes extracted from the beacon signal. Additionally or alternatively, customer computing device 302 may send, to customer assistance computing platform 324, information that includes one or more identifiers that are assigned to customer computing device 302, one or more software applications running on customer computing device 302, one or more users of and/or user accounts associated with customer computing device 302, and/or one or more other identifiers that are otherwise associated with customer computing device 302. For instance, customer computing device 302 may send, to customer assistance computing platform 324, an identifier and/or other data that is linked to, and can be used by customer assistance computing platform 324 to identify, customer computing device 302. Additionally or alternatively, customer computing device 302 may send, to customer assistance computing platform 324, an identifier and/or other data that is linked to, and can be used by customer assistance computing platform 324 to identify, a user of customer computing device 302 (e.g., login information entered by the user of customer computing device 302 to access and/or use one or more functions provided by customer computing device 302, a username associated with the user of customer computing device 302 and used in accessing a mobile banking application and/or a mobile banking website on customer computing device 302, and/or other information).

At step 4, customer assistance computing platform 324 may receive the one or more attributes and/or the one or more identifiers from customer computing device 302. For example, customer assistance computing platform 324 may receive, via communication interface 328, from customer computing device 302, the one or more attributes associated with the beacon signal received by customer computing device 302 and one or more identifiers associated with customer computing device 302. In some embodiments, the one or more identifiers associated with the customer computing device may include user account information associated with a mobile banking application on the customer computing device. For example, at least one identifier of the one or more identifiers that may be received by customer assistance computing platform 324 from customer computing device 302 at step 4 may include user account information associated with a mobile banking application installed on, running on, and/or otherwise associated with customer computing device 302. Such user account information may, for example, include a username, password, account number, and/or other user-specific information that may be used in accessing various functions of the mobile banking application and/or a mobile banking website (which may, e.g., be provided by the financial institution operating banking center 304).

In some instances, in addition to receiving one or more attributes associated with a beacon signal and at least one identifier from customer computing device 302, customer assistance computing platform 324 also may receive biometric input information from customer computing device 302. Such biometric input information may, for instance, be captured by a mobile banking application installed on, running on, and/or otherwise associated with customer computing device 302. For example, at and/or after step 4, customer assistance computing platform 324 may receive, via communication interface 328, from customer computing device 302, biometric input information captured by a mobile banking application on the customer computing device. The biometric input information received by customer assistance computing platform 324 from customer computing device 302 may, for example, include information associated with one or more fingerprints, retina scans, voiceprints, facial images, and/or other biometrics associated with the user of customer computing device 302.

At step 5, customer assistance computing platform 324 may determine the identity of a customer based on the one or more identifiers received from customer computing device 302. For example, customer assistance computing platform 324 may determine an identity of a customer using customer computing device 302 based on the identifier associated with the customer computing device (which may, e.g., have been received at step 4). In instances in which customer computing device 302 also sent, and customer assistance computing platform 324 received, biometric input information, customer assistance computing platform 324 may use the received biometric input information in identifying and/or authenticating the customer using customer computing device 302. For example, in determining the identity of the customer using customer computing device 302 in such instances, customer assistance computing platform 324 may confirm the identity of the customer using customer computing device 302 based on the biometric input information (which may, e.g., have been captured by the mobile banking application on the customer computing device).

At step 6, customer assistance computing platform 324 may determine the location of the customer based on the one or more attributes received from customer computing device 302. For example, customer assistance computing platform 324 may determine a location of the customer using customer computing device 302 based on the one or more attributes associated with the beacon signal received by customer computing device 302. In one or more embodiments, the location of the customer using the customer computing device may be determined based on information identifying the known deployment location of the location beacon from which the customer computing device received the beacon signal. In some embodiments, determining the location of the customer using the customer computing device may thus include accessing beacon deployment information that maps identifiers for a plurality of location beacons to corresponding deployment locations of the plurality of location beacons. The deployment locations of the plurality of location beacons (which may, e.g., be mapped in the beacon deployment information) may, for example, include two or more different banking centers that are operated by the financial institution, specific areas of various banking centers operated by the financial institution, and/or other areas associated with the financial institution.

In some embodiments, determining the location of the customer using the customer computing device may include determining that the customer using the customer computing device is located in a specific area of a banking center, such as banking center 304. For example, in addition to determining that the customer using customer computing device 302 is located at and/or near a particular banking center, such as banking center 304, customer assistance computing platform 324 may determine that the customer using customer computing device 302 is located in a particular area of the banking center, such as in the main lobby of the banking center, in a teller line, in a waiting area, in or outside of a particular office, in an automated teller machine (ATM) vestibule, in a parking lot outside of the banking center, at an external ATM outside of the banking center, in a particular drive-up service lane outside of the banking center, and/or the like.

At step 7, customer assistance computing platform 324 may select a queue from one or more available queues to which the customer may be added. The selected queue may, for example, be an ordered list of customers maintained by customer assistance computing platform 324 that includes information about one or more customers waiting for service at the banking center or other location where the customer using customer computing device 302 was determined to be located. Thus, customer assistance computing platform 324 may select at least one queue from one or more maintained queues based on the location of the customer using the customer computing device. In some embodiments, selecting at least one queue from the one or more maintained queues may include selecting a general queue of one or more customers waiting for service at the banking center. For example, customer assistance computing platform 324 may maintain various queues for customers waiting at the particular location, such as banking center 304, and the queue selected at step 7 may be a general queue of customers waiting for service at the determined location.

At step 8, customer assistance computing platform 324 may update the selected queue to add the identified customer to the selected queue. For example, customer assistance computing platform 324 may update the at least one selected queue based on the identity of the customer using customer computing device 302 to add the customer using customer computing device 201 to the at least one selected queue.

At step 9, customer assistance computing platform 324 may generate a notification indicating that the customer using customer computing device 302 has been added to selected queue. For example, customer assistance computing platform 324 may generate a notification indicating that the customer using customer computing device 302 has been added to the general queue of one or more customers waiting for service at banking center 304. At step 10, customer assistance computing platform 324 may send, via communication interface 328, to customer computing device 302, the generated notification. Additionally or alternatively, customer assistance computing platform 324 may send, via communication interface 328, to associate computing device 334, the generated notification.

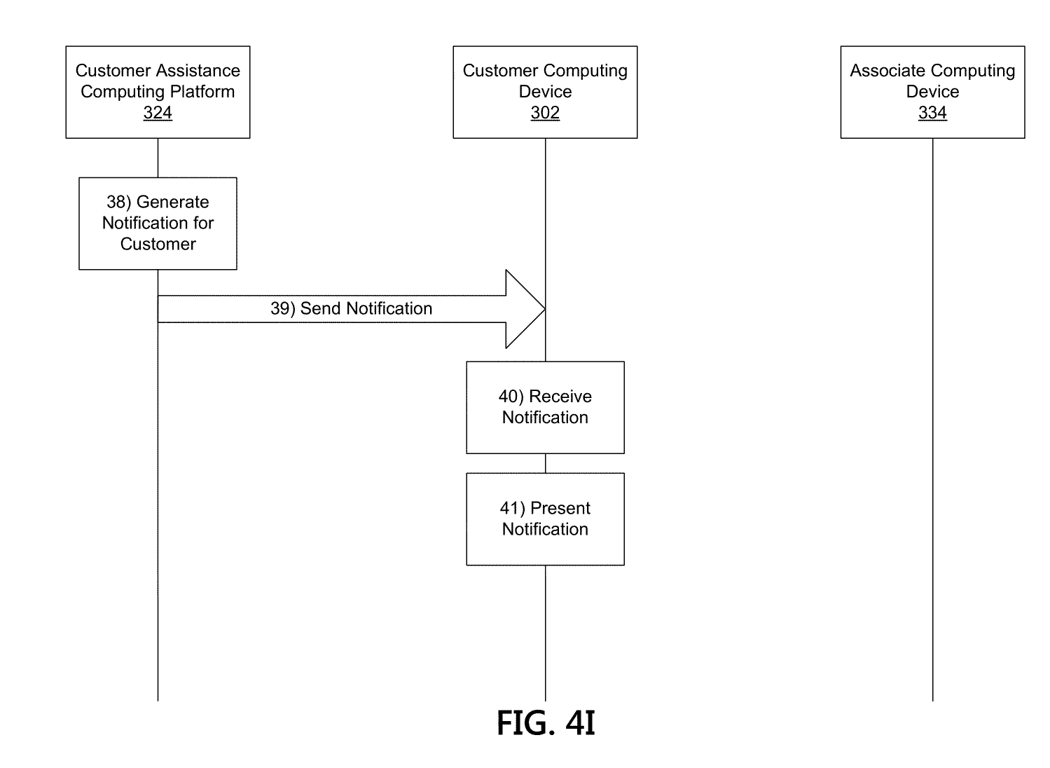

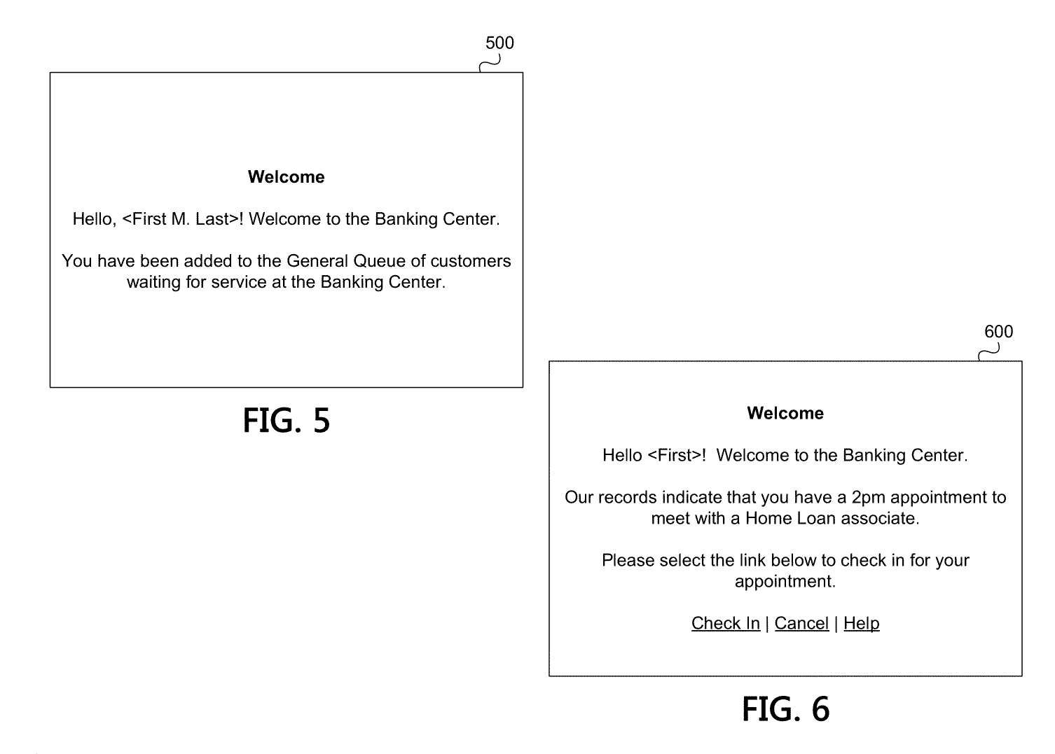

At step 11, customer computing device 302 may receive, via communication interface 308, from customer assistance computing platform 324, the notification indicating that the customer using customer computing device 302 has been added to the general queue of one or more customers waiting for service at banking center 304. At step 12, customer computing device 302 may present the received notification. In presenting the notification, customer computing device 302 may, for example, display, cause to be displayed, and/or otherwise present a graphical user interface similar to graphical user interface 500 as seen in FIG. 5.

Referring to FIG. 4C, at step 13, customer assistance computing platform 324 may access appointment information associated with the customer using customer computing device 302. For example, in accessing such appointment information, customer assistance computing platform 324 may load appointment records for the identified customer.

At step 14, customer assistance computing platform 324 may generate a request for visit information, and such a request may be generated based on the appointment information associated with the customer using customer computing device 302, if any such appointment information is available. For example, customer assistance computing platform 324 may generate, based on the appointment information associated with the customer using customer computing device 302, a request for visit information associated with the customer's current visit to the banking center (e.g., banking center 304). If, for instance, the customer using customer computing device 302 has an appointment to meet with an associate at banking center 304 at or substantially close to the current date and/or time, the request for visit information may prompt the customer to check in for his or her appointment. Alternatively, if the customer using customer computing device 302 does not have an appointment to meet with an associate at banking center 304 at or substantially close to the current date and/or time, the request for visit information may prompt the customer to identify one or more reasons for visiting banking center 304.

At step 15, customer assistance computing platform 324 may send, via communication interface 308, to customer computing device 302, the request for visit information. At step 16, customer computing device 302 may receive the request for visit information from customer assistance computing platform 324. At step 17, customer computing device 302 may present a notification based on the request for visit information received from customer assistance computing platform 324. In presenting such a notification, customer computing device 302 may, for example, display, cause to be displayed, and/or otherwise present a graphical user interface similar to graphical user interface 600 as seen in FIG. 6. In the example illustrated in FIG. 6, the user of customer computing device 302 may have an appointment to meet with someone at the banking center, and graphical user interface 600 may include one or more links, controls, and/or other elements that are configured to allow the user of customer computing device 302 to check in for his or her appointment. In instances in which the user of customer computing device 302 does not have an appointment, the graphical user interface that may be presented at step 17 may include other links, controls, and/or elements that may, for example, allow the user of customer computing device 302 to indicate their needs and/or reasons for visiting the banking center.

Referring to FIG. 4D, at step 18, customer computing device 302 may receive visit input from the user of customer computing device 302. Such visit input may, for example, be provided by the user of customer computing device 302 in response to the notification presented at step 17 and may include a request to check in for a scheduled appointment, a request for assistance, an indication of one or more needs and/or reasons for the customer's visit to the banking center, and/or other information. At step 19, customer computing device 302 may send the visit input to customer assistance computing platform 324.

At step 20, customer assistance computing platform 324 may receive, via communication interface 328, from customer computing device 302, the visit input. For example, at step 20, customer assistance computing platform 324 may receive, from customer computing device 302, the visit input provided by the user of customer computing device 302 in response to the request for visit information. At step 21, customer assistance computing platform 324 may select one or more service-specific queues (e.g., to which the customer using customer computing device 302 may be added) based on the visit input received from customer computing device 302. For example, at step 21, customer assistance computing platform 324 may select, based on the visit input, at least one service-specific queue from the one or more maintained queues. In some embodiments, each of the at least one selected service-specific queue may provide a separate virtual waiting line for one or more customers waiting for a specific service of one or more available services at the banking center. For example, different service-specific queues may provide distinct virtual waiting lines for customers waiting for different types of services. For instance, a home-mortgage service-specific queue may provide a distinct virtual waiting line for customers waiting for assistance with home-mortgage services, a brokerage service-specific queue may provide a distinct virtual waiting line for customers waiting for assistance with brokerage services, a commercial-banking service-specific queue may provide a distinct virtual waiting line for customers waiting for assistance with commercial-banking services, and so on.

At step 22, customer assistance computing platform 324 may update the one or more selected service-specific queues to add the identified customer to the one or more selected queues. For example, at step 22, customer assistance computing platform 324 may update the at least one selected service-specific queue based on the identity of the customer using customer computing device 302 to add the customer using customer computing device 302 to the at least one selected service-specific queue. In some instances, the customer using customer computing device 302 may be placed in a dedicated queue of one or more customers who have arrived at the banking center early for their corresponding appointment(s). For example, a customer that has an appointment, but is early for his or her appointment (e.g., the customer arrived at the banking center more than five or ten minutes before his or her scheduled appointment), may be placed in a special queue of customers who are early for their appointments but waiting to meet with a specialized associate at the banking center.

At step 23, customer assistance computing platform 324 may pre-authenticate the customer using customer computing device 302 to perform one or more specific transactions and/or one or more specific types of transactions. By pre-authenticating the customer to perform such transactions and/or types of transactions, customer assistance computing platform 324 may save the customer using customer computing device 302 from having to provide additional credentials to perform the specific transactions and/or types of transactions, such as small withdrawals, deposits, loan payments, and the like. In some instances, the customer using customer computing device 302 may be pre-authenticated to perform one or more specific transactions based on the appointment information and the visit input. For example, the pre-authentication of the customer using customer computing device 302, by customer assistance computing platform 324, may be based on the detection of the presence of the customer's personal computing device (e.g., customer computing device 302) at the banking center (e.g., banking center 304) in combination with appointment information indicating that the customer is expected to be at the banking center at the current time. Such appointment information may, for instance, include information about one or more appointments requested and/or scheduled by the customer using customer computing device 302, and such information may be obtained by customer assistance computing platform 324 by accessing and/or integrating with a bank-by-appointment system used by the financial institution operating the banking center and/or based on the customer using customer computing device 302 checking in for an appointment at the banking center. In some embodiments, the customer using customer computing device 302 may be pre-authenticated to perform one or more specific transactions based on biometric input information received from customer computing device 302. For example, instead of and/or in addition to using the appointment information in combination with the detection of the presence of the customer's personal computing device (e.g., customer computing device 302) at the banking center (e.g., banking center 304), customer assistance computing platform 324 may additionally or alternatively use biometric input information received from customer computing device 302 in pre-authenticating the customer using customer computing device 302 to perform one or more specific transactions and/or one or more specific types of transactions.

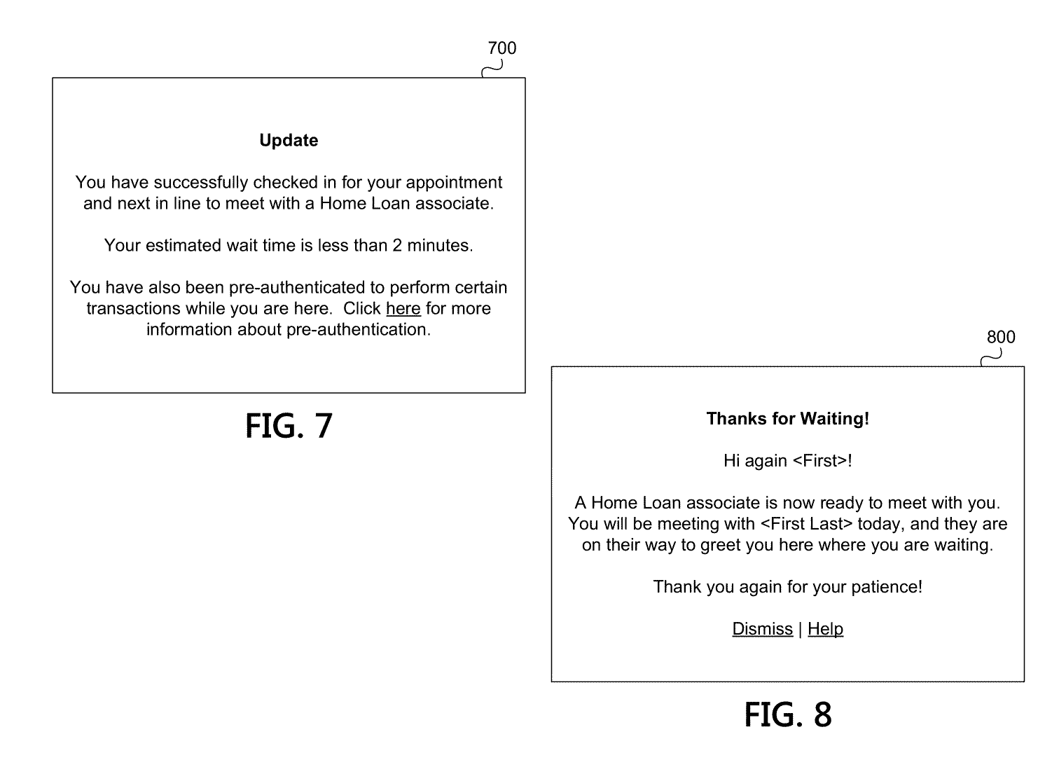

At step 24, customer assistance computing platform 324 may generate a confirmation message for the customer using customer computing device 302. The confirmation message may, for example, include information indicating and/or confirming that the customer using customer computing device 302 has been added to one or more queues, has been pre-authenticated to perform one or more specific transactions and/or one or more specific types of transactions, and/or the like. At step 25, customer assistance computing platform 324 may send the confirmation message to customer computing device 302. At step 26, customer computing device 302 may receive the confirmation message from customer assistance computing platform 324. At step 27, customer computing device 302 may present a notification based on the confirmation message received from customer assistance computing platform 324. In presenting such a notification based on a confirmation message, customer computing device 302 may, for example, display, cause to be displayed, and/or otherwise present a graphical user interface similar to graphical user interface 700 as seen in FIG. 7.

Referring to FIG. 4G, at step 28, customer assistance computing platform 324 may generate a notification for one or more associates at the banking center (e.g., banking center 304). Such a notification may, for example, indicate that the customer using customer computing device 302 has been added to one or more queues, has been pre-authenticated to perform one or more specific transactions and/or one or more specific types of transactions, and/or the like. At step 324, customer assistance computing platform 324 may send the notification to associate computing device 334 and/or one or more other computing devices that may be used by and/or otherwise linked to associates of the financial institution at the banking center (e.g., banking center 304). At step 30, associate computing device 334 may receive the notification, and at step 31, associate computing device 334 may present the notification received from customer assistance computing platform 324.

Subsequently, customer assistance computing platform 324 may maintain one or more queues of customers, such as one or more queues of customers waiting at banking center 304, including the one or more queues to which the user of user computing device 302 has been added. In maintaining the one or more queues of customers, customer assistance computing platform 324 may, for example, assign various associates of the financial institution to assist specific customers as such associates become available to assist such customers and/or based on one or more factors, including the order in which the customers were added to the respective queues.

At step 32, customer assistance computing platform 324 may determine that a banking center associate at banking center 304 is available to assist one or more customers at banking center 304. At step 33, customer assistance computing platform 324 may select the customer using customer computing device 302 from the at least one queue (e.g., to which the customer using customer computing device 302 was added) to receive assistance from the banking center associate at banking center 304 that is available to assist one or more customers at banking center 304. For example, at step 33, customer assistance computing platform 324 may determine that it is the identified customer's turn in one or more queues in which the customer may be waiting, such as the general queue of customers waiting at banking center 304, one or more service-specific queues of customers waiting at banking center 304, and/or the like.

At step 34, customer assistance computing platform 324 may generate a notification indicating that the banking center associate at banking center 304 that is available to assist one or more customers at banking center 304 has been assigned to assist the customer using customer computing device 302. At step 35, customer assistance computing platform 324 may send, via communication interface 328, to associate computing device 334 (which may, e.g., be linked to, used by, and/or otherwise associated with the banking center associate at banking center 304 that is available to assist one or more customers at banking center 304), the notification generated at step 34. At step 36, associate computing device 334 may receive the notification from customer assistance computing platform 324, and at step 37, associate computing device 334 may present the notification received from customer assistance computing platform 324.

At step 38, customer assistance computing platform 324 may generate a notification indicating that the customer using customer computing device 302 has been selected to receive assistance from the banking center associate at banking center 304 that is available to assist one or more customers at banking center 304. At step 39, customer assistance computing platform 324 may send, via communication interface 328, to customer computing device 302, the notification generated at step 38. In some embodiments, the notification may include a picture of the banking center associate. For example, the notification may include a picture of the banking center associate at banking center 304 that is available to assist one or more customers at banking center 304 and that has been assigned to assist the customer using customer computing device 302. At step 40, customer computing device 302 may receive the notification from customer assistance computing platform 324, and at step 41, customer computing device 302 may present the notification received from customer assistance computing platform 324. In presenting such a notification, customer computing device 302 may, for example, display, cause to be displayed, and/or otherwise present a graphical user interface similar to graphical user interface 800 as seen in FIG. 8.

In some embodiments, one or more events different from those discussed above may be performed if, for instance, the customer computing device 302 that is detected and/or otherwise recognized at banking center 304 by customer assistance computing platform 324 is determined to belong to a person who is not a current customer of the financial institution operating banking center 304. For example, in these instances, customer assistance computing platform 324 may generate and/or send a prompt to customer computing device 302 asking the user of customer computing device 302 to download and/or install a certain application, view certain content (e.g., advertising content about opening an account and/or other information about services that may be available at banking center 304), and/or perform other actions. Additionally or alternatively, one or more events of those discussed above may be repeated for a second customer who may be using a second customer computing device similar to customer computing device 302.

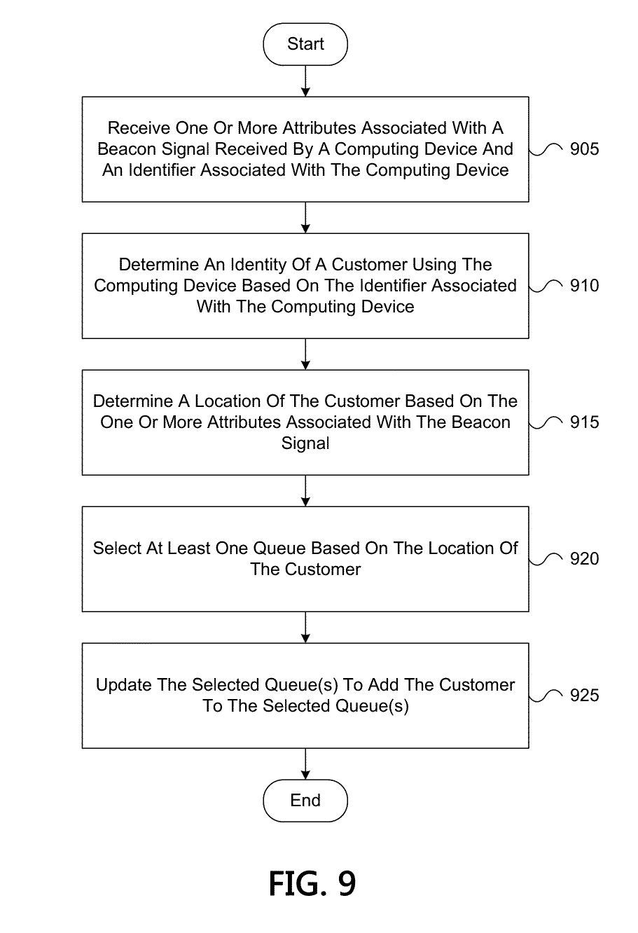

FIG. 9 depicts an illustrative method for managing customer queues using local positioning technology in accordance with one or more example embodiments. As seen in FIG. 9, at step 905, a computing platform may receive one or more attributes associated with a beacon signal received by a computing device and an identifier associated with the computing device. At step 910, the computing platform may determine an identity of a customer using the computing device based on the identifier associated with the computing device. At step 915, the computing platform may determine a location of the customer based on the one or more attributes associated with the beacon signal. At step 920, the computing platform may select at least one queue based on the location of the customer. At step 925, the computing platform may update the at least one selected queue to add the customer to the at least one selected queue.

As illustrated above, systems and methods for providing enhanced retail customer experiences using indoor positioning technology are presented. In one or more example embodiments, a user may be identified based on a detection of a personal device of the user (e.g., a mobile computing device used by the user) at a particular location, such as a banking center. After the user is identified, the user may be placed in one or more queues to receive service. For example, the user may be placed in a general queue of customers waiting to receive service at the banking center and a specific queue of customers waiting to receive a specific type of service (e.g., a home mortgage service queue, a brokerage service queue, a commercial banking service queue, etc.). In some instances, after the user identified, a notification may be presented on the user's mobile device indicating that the user is present at the banking center and/or prompting the user to select one or more services for which the user has visited the banking center to receive. The user's response(s) to such a prompt may be used in determining which queue(s) to place the customer in.

In some instances, the user's personal device may be detected using indoor positioning system technology. After the user's personal device is detected at the banking center, the user might not be placed in one or more queues until the user manually “checks in” via a software application on the personal device. Additionally or alternatively, after the user's personal device is detected at the banking center, biometric data may be captured and used in identifying the user. In capturing and using biometric data in identifying the user, facial recognition techniques, fingerprint recognition techniques, and/or other biometric analysis techniques may be employed. After the user is placed in one or more queues, the user's personal device may present a picture of an associate at the banking center that the user will be meeting with. After the user's personal device is detected at the banking center, the user may be pre-authenticated to conduct one or more transactions. The pre-authentication may allow the user to conduct only specific types of transactions (e.g., small withdrawals, deposits, loan payments, and the like). Additionally or alternatively, the pre-authentication may be based on the detection of the user's personal device and/or information about one or more appointments scheduled by the user (which may, e.g., be obtained by integrating with a bank-by-appointment system). In some instances, a customer with an appointment may be placed in a special queue of customers who are early for their appointments but waiting to meet with a banking center associate.

One or more aspects of the disclosure may be embodied in computer-usable data or computer-executable instructions, such as in one or more program modules, executed by one or more computers or other devices to perform the operations described herein. Generally, program modules include routines, programs, objects, components, data structures, and the like that perform particular tasks or implement particular abstract data types when executed by one or more processors in a computer or other data processing device. The computer-executable instructions may be stored on a computer-readable medium such as a hard disk, optical disk, removable storage media, solid-state memory, RAM, and the like. The functionality of the program modules may be combined or distributed as desired in various embodiments. In addition, the functionality may be embodied in whole or in part in firmware or hardware equivalents, such as integrated circuits, application-specific integrated circuits (ASICs), field programmable gate arrays (FPGA), and the like. Particular data structures may be used to more effectively implement one or more aspects of the disclosure, and such data structures are contemplated to be within the scope of computer executable instructions and computer-usable data described herein.

Various aspects described herein may be embodied as a method, an apparatus, or as one or more computer-readable media storing computer-executable instructions. Accordingly, those aspects may take the form of an entirely hardware embodiment, an entirely software embodiment, an entirely firmware embodiment, or an embodiment combining software, hardware, and firmware aspects in any combination. In addition, various signals representing data or events as described herein may be transferred between a source and a destination in the form of light or electromagnetic waves traveling through signal-conducting media such as metal wires, optical fibers, or wireless transmission media (e.g., air or space). In general, the one or more computer-readable media may comprise one or more non-transitory computer-readable media.

As described herein, the various methods and acts may be operative across one or more computing servers and one or more networks. The functionality may be distributed in any manner, or may be located in a single computing device (e.g., a server, a client computer, and the like). For example, in alternative embodiments, one or more of the computing platforms discussed above may be combined into a single computing platform, and the various functions of each computing platform may be performed by the single computing platform. In such arrangements, any and/or all of the above-discussed communications between computing platforms may correspond to data being accessed, moved, modified, updated, and/or otherwise used by the single computing platform. Additionally or alternatively, one or more of the computing platforms discussed above may be implemented in one or more virtual machines that are provided by one or more physical computing devices. In such arrangements, the various functions of each computing platform may be performed by the one or more virtual machines, and any and/or all of the above-discussed communications between computing platforms may correspond to data being accessed, moved, modified, updated, and/or otherwise used by the one or more virtual machines.

Aspects of the disclosure have been described in terms of illustrative embodiments Thereof. Numerous other embodiments, modifications, and variations within the scope and spirit of the appended claims will occur to persons of ordinary skill in the art from a review of this disclosure. For example, one or more of the steps depicted in the illustrative figures may be performed in other than the recited order, and one or more depicted steps may be optional in accordance with aspects of the disclosure.

What is claimed is:

1. A method, comprising:
at a customer assistance computing platform comprising at least one processor, memory, and a communication interface:
receiving, by the at least one processor, via the communication interface, from a customer computing device, one or more attributes associated with a beacon signal received by the customer computing device and an identifier associated with the customer computing device;
determining, by the at least one processor, an identity of a customer using the customer computing device based on the identifier associated with the customer computing device;
determining, by the at least one processor, a location of the customer using the customer computing device based on the one or more attributes associated with the beacon signal received by the customer computing device;
selecting, by the at least one processor, at least one queue from one or more maintained queues based on the location of the customer using the customer computing device; and
updating, by the at least one processor, the at least one selected queue based on the identity of the customer using the customer computing device to add the customer using the customer computing device to the at least one selected queue.

2. The method of claim 1, wherein the beacon signal received by the customer computing device is associated with at least one beacon deployed at a banking center.

3. The method of claim 2, wherein the one or more attributes associated with the beacon signal received by the customer computing device include a unique identifier associated with the at least one beacon deployed at the banking center.

4. The method of claim 3, wherein the identifier associated with the customer computing device includes user account information associated with a mobile banking application on the customer computing device.

5. The method of claim 4, further comprising:
receiving, by the at least one processor, via the communication interface, from the customer computing device, biometric input information captured by the mobile banking application on the customer computing device.

6. The method of claim 5, wherein determining the identity of the customer using the customer computing device includes confirming the identity of the customer using the customer computing device based on the biometric input information captured by the mobile banking application on the customer computing device.

7. The method of claim 3, wherein determining the location of the customer using the customer computing device includes accessing beacon deployment information that maps identifiers for a plurality of beacons to corresponding deployment locations of the plurality of beacons.

8. The method of claim 7, wherein determining the location of the customer using the customer computing device includes determining that the customer using the customer computing device is located in a specific area of the banking center.

9. The method of claim 2, wherein selecting at least one queue from the one or more maintained queues includes selecting a general queue of one or more customers waiting for service at the banking center.

10. The method of claim 9, further comprising:
generating, by the at least one processor, a notification indicating that the customer using the customer computing device has been added to the general queue of one or more customers waiting for service at the banking center; and
sending, by the at least one processor, via the communication interface, to the customer computing device, the notification.

11. The method of claim 2, further comprising:
accessing, by the at least one processor, appointment information associated with the customer using the customer computing device;
generating, by the at least one processor, based on the appointment information associated with the customer using the customer computing device, a request for visit information associated with the customer's current visit to the banking center; and
sending, by the at least one processor, via the communication interface, to the customer computing device, the request for visit information.

12. The method of claim 11, further comprising:
receiving, by the at least one processor, via the communication interface, from the customer computing device, visit input provided in response to the request for visit information;
selecting, by the at least one processor, based on the visit input, at least one service-specific queue from the one or more maintained queues; and
updating, by the at least one processor, the at least one selected service-specific queue based on the identity of the customer using the customer computing device to add the customer using the customer computing device to the at least one selected service-specific queue.

13. The method of claim 12, wherein each of the at least one selected service-specific queue provides a separate virtual waiting line for one or more customers waiting for a specific service of one or more available services at the banking center.

14. The method of claim 12, wherein the customer using the customer computing device is placed in a dedicated queue of one or more customers who have arrived at the banking center early for one or more corresponding appointments.

15. The method of claim 12, wherein the customer using the customer computing device is pre-authenticated to perform one or more specific transactions based on the appointment information and the visit input.

16. The method of claim 12, wherein the customer using the customer computing device is pre-authenticated to perform one or more specific transactions based on biometric input information received from the customer computing device.

17. The method of claim 2, further comprising:
determining, by the at least one processor, that a banking center associate at the banking center is available to assist one or more customers at the banking center;
selecting, by the at least one processor, the customer using the customer computing device from the at least one queue to receive assistance from the banking center associate;
generating, by the at least one processor, a first notification indicating that the customer using the customer computing device has been selected to receive assistance from the banking center associate;
sending, by the at least one processor, via the communication interface, to the customer computing device, the first notification;
generating, by the at least one processor, a second notification indicating that the banking center associate has been assigned to assist the customer using the customer computing device; and
sending, by the at least one processor, via the communication interface, to a computing device associated with the banking center associate, the second notification.

18. The method of claim 17, wherein the first notification includes a picture of the banking center associate.

19. A system, comprising:
at least one processor;
a communication interface communicatively coupled to the at least one processor; and
memory storing computer-readable instructions that, when executed by the at least one processor, cause the system to:
receive, via the communication interface, from a customer computing device, one or more attributes associated with a beacon signal received by the customer computing device and an identifier associated with the customer computing device;
determine an identity of a customer using the customer computing device based on the identifier associated with the customer computing device;
determine a location of the customer using the customer computing device based on the one or more attributes associated with the beacon signal received by the customer computing device;
select at least one queue from one or more maintained queues based on the location of the customer using the customer computing device; and
update the at least one selected queue based on the identity of the customer using the customer computing device to add the customer using the customer computing device to the at least one selected queue.

20. One or more non-transitory computer-readable media storing instructions that, when executed by a computing device comprising at least one processor, memory, and a communication interface, cause the computing device to:
receive, via the communication interface, from a customer computing device, one or more attributes associated with a beacon signal received by the customer computing device and an identifier associated with the customer computing device;
determine an identity of a customer using the customer computing device based on the identifier associated with the customer computing device;
determine a location of the customer using the customer computing device based on the one or more attributes associated with the beacon signal received by the customer computing device;
select at least one queue from one or more maintained queues based on the location of the customer using the customer computing device; and
update the at least one selected queue based on the identity of the customer using the customer computing device to add the customer using the customer computing device to the at least one selected queue.
